(19) United States
(12) Patent Application Publication
(10) Pub. No.: US 2009/0115594 A1
(43) Pub. Date: May 7, 2009

(54) Vehicular wireless signal controller and its control method

(76) Inventor: WEI-JER HAN, Federal Way, WA (US)

Correspondence Address: WEI-JER HAN, 2428 SW 349TH PL, FEDERAL WAY, WA, 98023-3067, US

(21) Appl. No.: 12/242,931

(22) Filed: Oct. 1, 2008

(30) Foreign Application Priority Data
Nov. 2, 2007 (CN) 200710165260.4

(51) Int. Cl. B60Q 1/52

(52) U.S. Cl. 340/471

(57) ABSTRACT

A vehicular wireless signal controller to work in an emergency warning system is provided that is simultaneously operable through a control head or a remote. The vehicular wireless signal controller includes a remote, a control head, a remote receiver and a control unit. The driver in pursuit or high speed chase situation because of emergent duty or timing wants to operate the emergency signaling system, he or she may needs to look for the control head. As a result, the driver can't mind his or her road's condition and it may cause accidents easily. A remote can be mounted on the top of turning axis of the steering wheel's shaft where is very close to the driver's hands holding with to improve the operability of the signaling system and reduce hazardous situation while in use with emergency vehicles.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention is a wireless signal controller and its control method of transmitting and receiving signals. The said controller usually works with emergency vehicles such as police cars, fire engines, and ambulances.

In the past, the emergency signal system is self contained in an enclosure. The unit is installed nearby the driver or on the dashboard, and its controller is on one side of the enclosure. Occupying too much space in the driver cabinet is the biggest disadvantage.

Recently, due to the increasing demand on the space for the air bag and other in-vehicle electronics, more and more emergency signaling systems are split into a control head and a control unit, and a hardwired connection established between them. The control head is installed nearby the driver, and the control unit is installed inside the trunk or under the seat. Such arrangement indeed saves some space in driver's cabinet.

However, the arrangement still does not solve a safety problem while driving an emergency vehicle. The driver in pursuit or high speed chase situation because of emergent duty or timing wants to operate the emergency signaling system, he or she may needs to look for the control head. As a result, the driver can't mind his or her road's condition and it may cause accidents easily.

### BRIEF SUMMARY OF THE INVENTION

A primary object of the invention is to provide a wireless signal controller to work in an emergency warning system. It contains a remote capable of been mounted close to the steering wheel for easy access and operation without moving focus out of the road condition.

Second object is to provide a controller to operate the emergency signaling system with reduced number of switch buttons.

Third object is to provide a wireless signal controller whose wireless communication address or identification code can be easily arranged to avoid conflict.

Last object is to provide an easy method to install a compact remote on the steering wheel and can be easily removed for battery change.

To achieve the foregoing objects, a vehicular wireless signal controller is provided to work in an emergency warning system. A remote can be mounted on the top of turning axis of the steering wheel's shaft where is very close to the driver's hands holding with. The system includes a remote, a control head, a remote receiver, and a control unit which amplifies the siren sound and controls the emergency lights. These elements are electrically hardwired together. The remote receiver is installed between the control head and the control unit which is responding to the received audible and visual signal from the remote.

### BRIEF DESCRIPTION OF THE SEVERAL VIEWS OF THE DRAWING

FIG. 1 is a block diagram illustrating the interconnection of existing emergency warning system;

FIG. 2 is a block diagram of this invention wherein a remote and a remote receiver are added to the existing emergency warning system as shown in FIG. 1;

FIG. 3 is a block diagram illustrating the internal connection of said remote;

FIG. 4 is a block diagram illustrating the internal connection of the remote receiver;

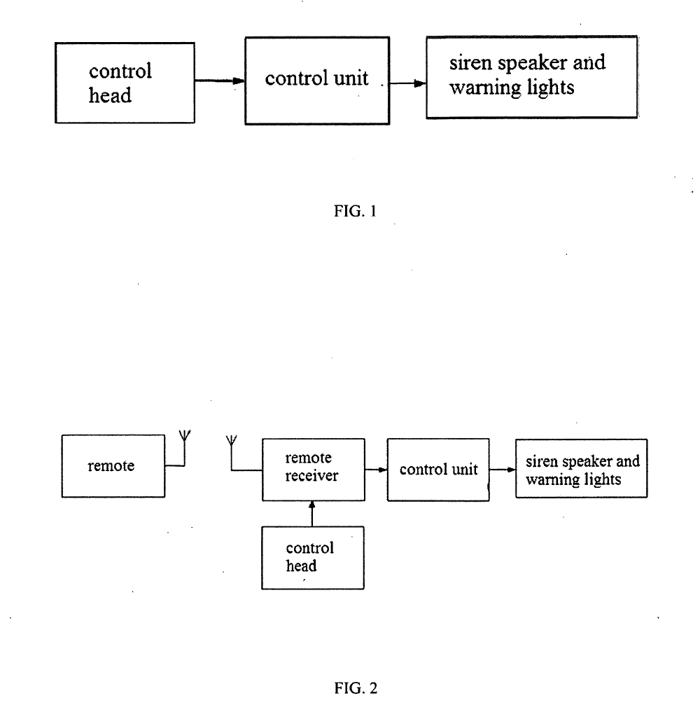

FIG. 5 is a schematic circuit diagram of the remote;
H. is the crystal oscillation circuit;
I. is the input circuitry for push button switches of said remote;
J. is the power up reset circuit;
K. is the single chip RF controller comprising a programmable microcontroller and a radio frequency transmitter;

FIG. 6 is a schematic circuit diagram of remote receiver with the integrated circuit UAA3201T;
A. is the circuitry of RF reception;
B. is the receiving microcontroller;
C. is the power up reset circuit;
D. is the EEPROM access circuitry used for learning, storing and reading the identification codes of said remote;
E. is the control head interface circuitry;
F. is the driver interface circuitry in the remote receiver;

FIG. 7 is a schematic circuit diagram of remote receiver with the RF module RXM-433-LR which is an alternative embodiment of the integrated circuit UAA3201T as shown in the FIG. 6;

FIG. 8 is a flow chart of said remote executing an identification programming, EEPROM access and recognizing single and double key depresses;

FIG. 9 is a flow chart of said remote receiver executing an identification learning, EEPROM access, CRC-8 error check as well as controlling the control unit;

FIG. 10 is a diagram indicating the preferable mounting location of the remote wherein a fastening strap is installed on the top of the steering wheel;
10 is a steering wheel of a vehicle;
20 is said remote;
21 are the mounting slots on both sides of said remote;
30 is a Velcro nylon strip or similar fastening strap to be tied around the shaft of a steering wheel;

FIG. 11 is a diagram illustrating the appearance of the remote;
20 is said remote;
21 are the mounting slots on both sides of said remote;
22 is the push button switch of said remote;
30 is a Velcro nylon strip or similar fastening strap to be tied around the shaft of a steering wheel;

FIG. 12 is a diagram illustrating the wire connection among said control head, said remote receiver and said control unit.
40 is said control head;
50 is said remote receiver;
60 is said control unit.

Because this invention is described with preferable embodiments, there is no intention to limit it to those embodiments. On the contrary, this patent will cover all alternatives, modifications, and equivalents falling within.

### DETAILED DESCRIPTION OF THE INVENTION

A vehicular wireless signal controller includes a remote, a control head, a remote receiver, and a control unit which amplifies the siren sound and controls the emergency lights. A remote can be mounted on the top of turning axis of the steering wheel's shaft where is very close to the driver's hands holding with. These elements are electrically hardwired together. The remote receiver is installed between the control head and the control unit which is responding to the received audible and visual signal from the remote.

On FIGS. 2, 10 and 12, a vehicular wireless signal controller is shown and comprising: a control head (#40); a control unit (#60) with electrical power devices controlling audible and visual warning signal; audible and visual warning transducers; a remote (#20), and a remote receiver (#50) which receives the control signal from the remote and controls the control unit.

FIG. 10 illustrates the preferable mounting location of the remote. About every 12 months, the battery in the remote may require to be replaced so we use the Velcro nylon strips or similar fastening strap (#30) to the the remote around the shaft of the steering wheel for easy access and replacement.

From the foregoing, it will be appreciated that a vehicular wireless signal controller has been provided that eliminates the hardwired connection so as to be able to install the remote close enough for the driver to operate the siren and emergency lights without changing focus from the road condition and thus alternatively reduces the hazardous condition and improve the safety while driving the emergency vehicle.

Said remote consists of a single chip RF controller, input circuitry for push button switches, a crystal oscillator, power source and a power up reset circuit. Integrated circuit rfPIC12F675F which is also a programmable microcontroller is utilized for the single chip RF controller, and connected with the input circuitry for push button switches, the crystal oscillator and the power up reset circuit. A type CR2032 coin cell battery is used for the power source. The integrated circuit rfPIC12F675F comprises a radio frequency transmitter and a programmable microcontroller. The programmable microcontroller encodes the communication protocol with ASK (amplitude Shift Keying) technology and controls the radio frequency transmitter to send RF signal with the carrier frequency set at 433.92 MHz. Said remote is installed on the top of turning axis of the steering wheel's shaft and has mounting slots on both sides, which allow Velcro nylon strips or similar fastening strap to be tied around the shaft of the steering wheel.

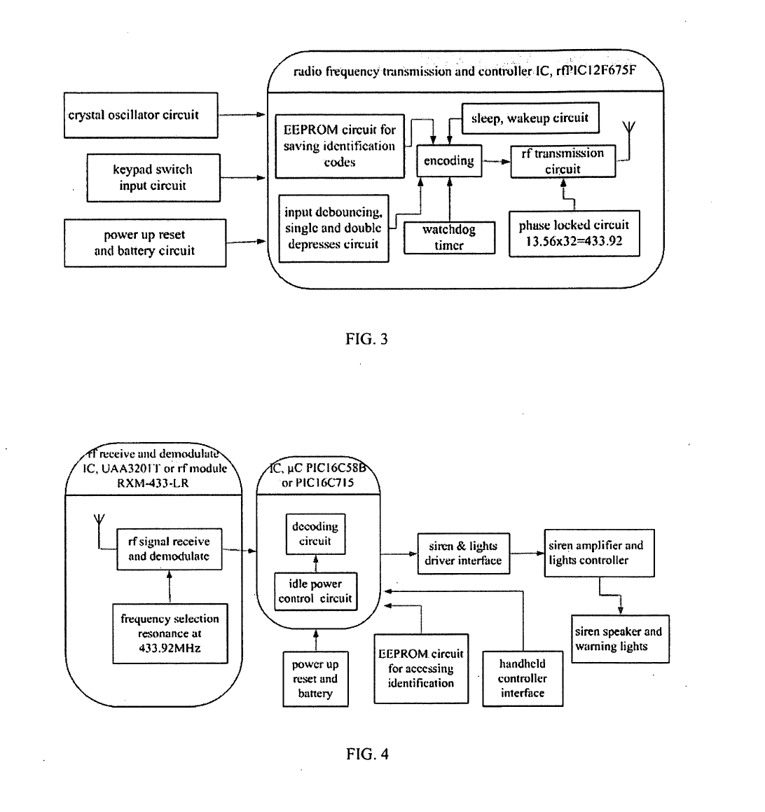

Referring to FIG. 3 and FIG. 5 The remote comprises: the single chip RF controller rfPIC12F675F as shown in reference K, the input circuitry for push button switches as shown in I, the power up reset circuit as shown in J, and the 13.56 MHz crystal oscillation circuit in H. The single chip RF controller rfPIC12F675F is electrically connected with the reference circuit I, J and H. A type CR2032 coin cell battery supplies the power to the remote. The power-up resets circuit J and supervise the initial voltage at power up to ensure the voltage being stable before the rfPIC12F675F starts working. After the rfPIC12F675F starts working, a reset command to the internal watchdog timer is necessary before the watchdog timer overflows and resets the rfPIC12F675F by itself. This conversely ensures the watchdog resetting routine to be executed within a limited time or the controller being still running properly. In order to reduce the numbers of push button switches in the remote, each switch detects single and double depresses and responds it with different function. It should be noted that the locations of the switches are aligned nonlinearly, that is there is no three buttons sitting in one line to help the driver's fingers easily find the buttons.

The rfPIC12F675F comprise: a programmable microcontroller and a radio frequency transmitter. More specifically, it is noted that the ASK (amplitude shift keying) is utilized for modulation and transmission with the carrier frequency set at 433.92 MHz because of using the particular rfPIC12F675F. The 13.56 MHz crystal oscillation will be multiplied by 32 inside the rfPIC12F675F to obtain the UHF carrier frequency 433.92 MHz.

Because the remote is powered by a battery, there is no audible or visual electricity consuming indicators installed within. Since the driver can hear the siren sound so there will be no indicator required when turning a siren amplifier on. However the control head can add adequate indication when an emergency light is activated by the remote. An audible piezoelectronic beeper and LED indicators are installed in the control head to feedback the status of the emergency lights. Upon any change to the status of the emergency lights, the beeper or LED on the control head will generate an audible and visual effect to notify the operator the change of the status.

Said remote receiver consists of a circuitry for RF reception, a receiving microcontroller, a power up reset circuit, a circuitry for EEPROM access, a control head interface circuitry, and a driver interface circuitry. The circuitry for RF reception is tuned to the carrier frequency same as the remote and demodulates the received signal to TTL digital voltage which then is fed to the receiving microcontroller for decoding. The receiving microcontroller operates the control unit as set forth in response to the valid received data, with the similar approaches that the control head as set forth uses in and controls the control unit through the driver interface circuitry to control audio and visual warning transducers. Integrated circuit UAA3201T or RF module RXM-433-LR is utilized for the circuitry for RF reception and the PIC16C58B or PIC16C715 is utilized for the receiving microcontroller. Said remote receiver is electrically hardwired with the control head and the control unit. It receives control signal from the remote.

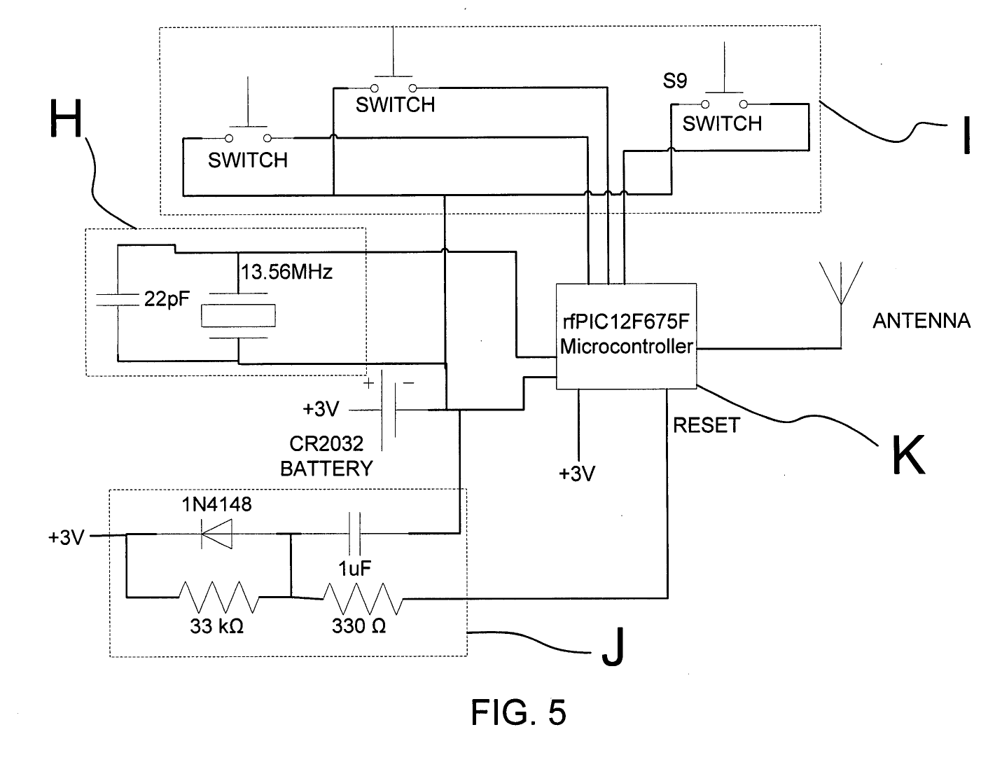

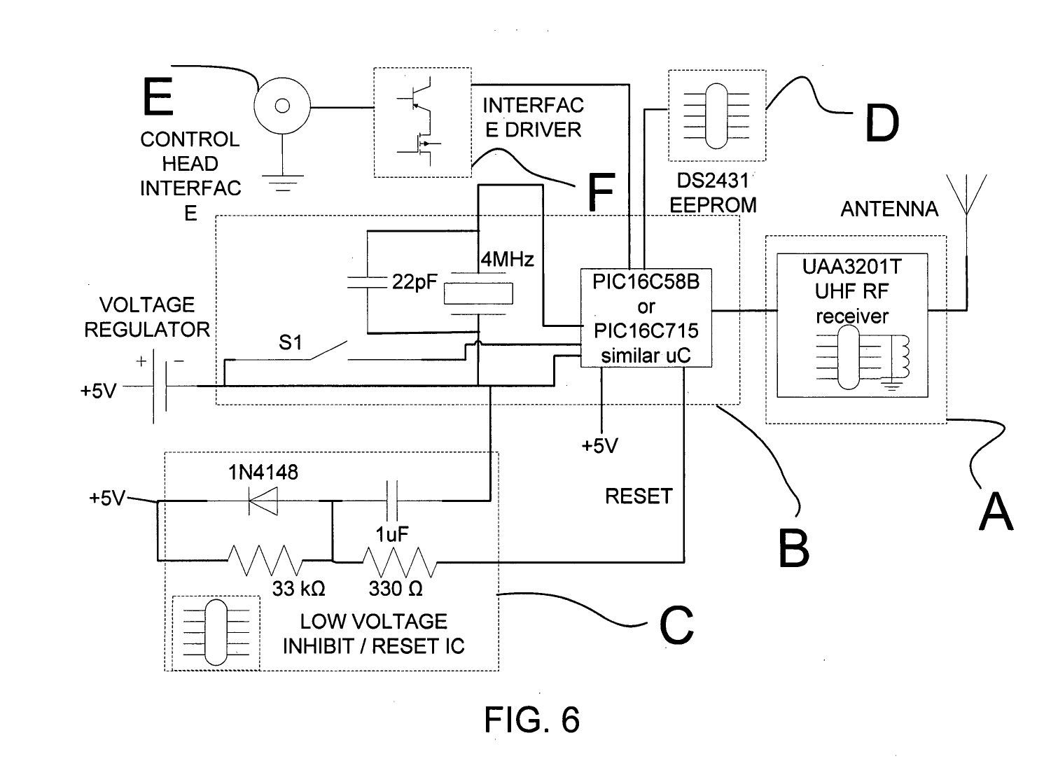

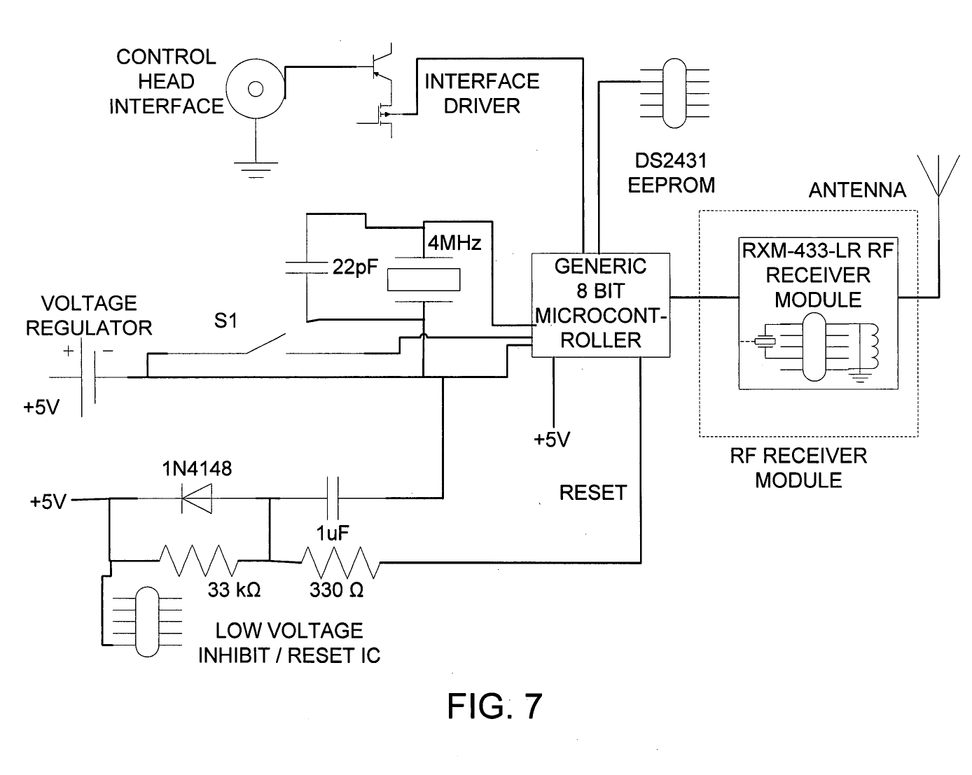

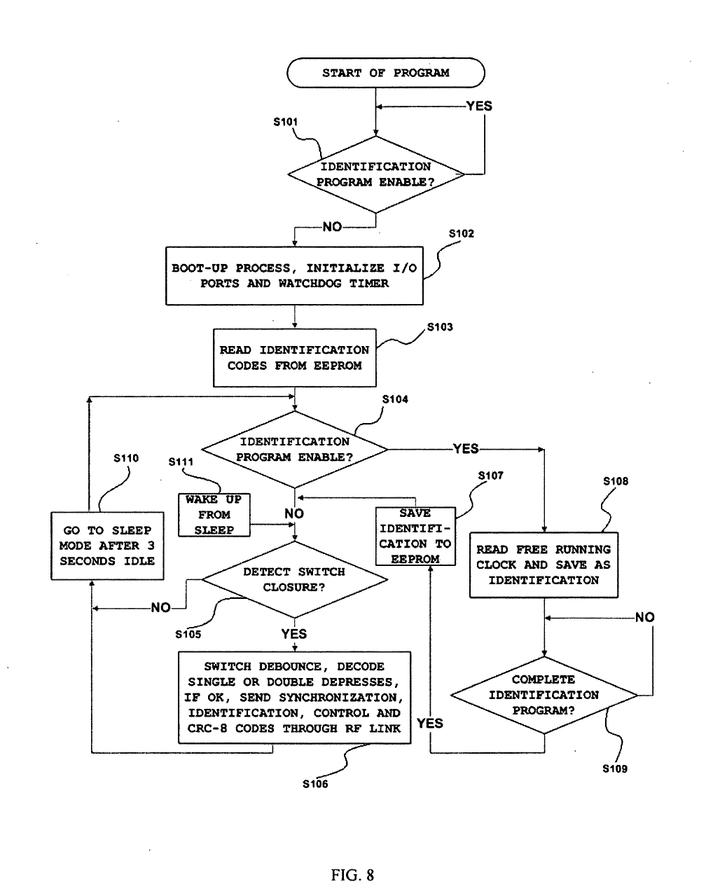

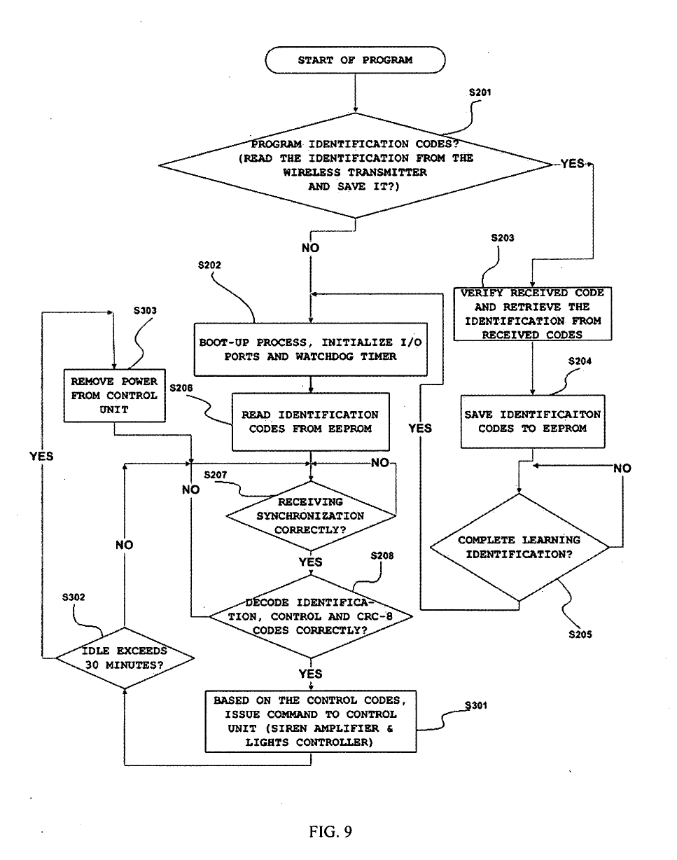

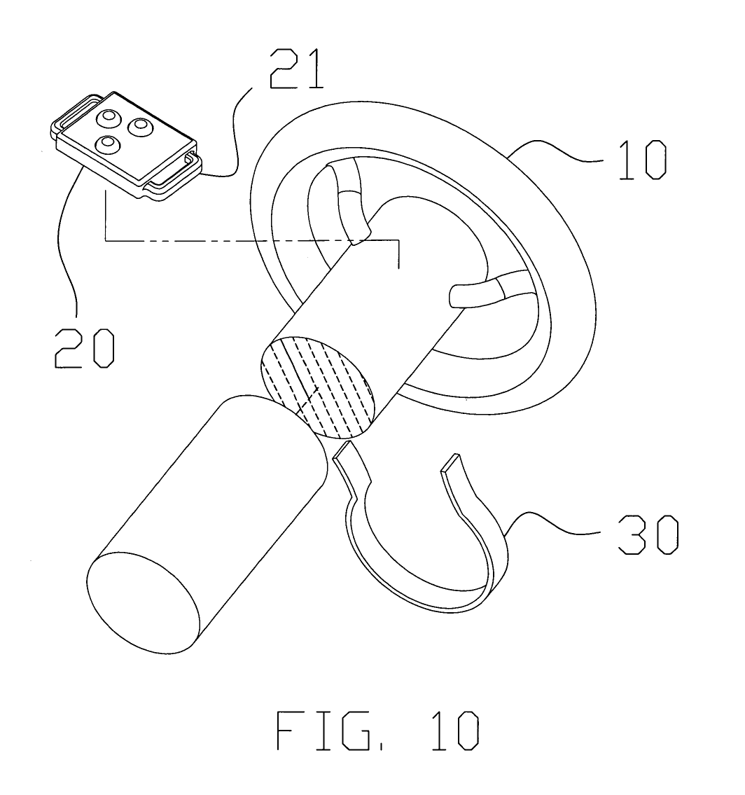

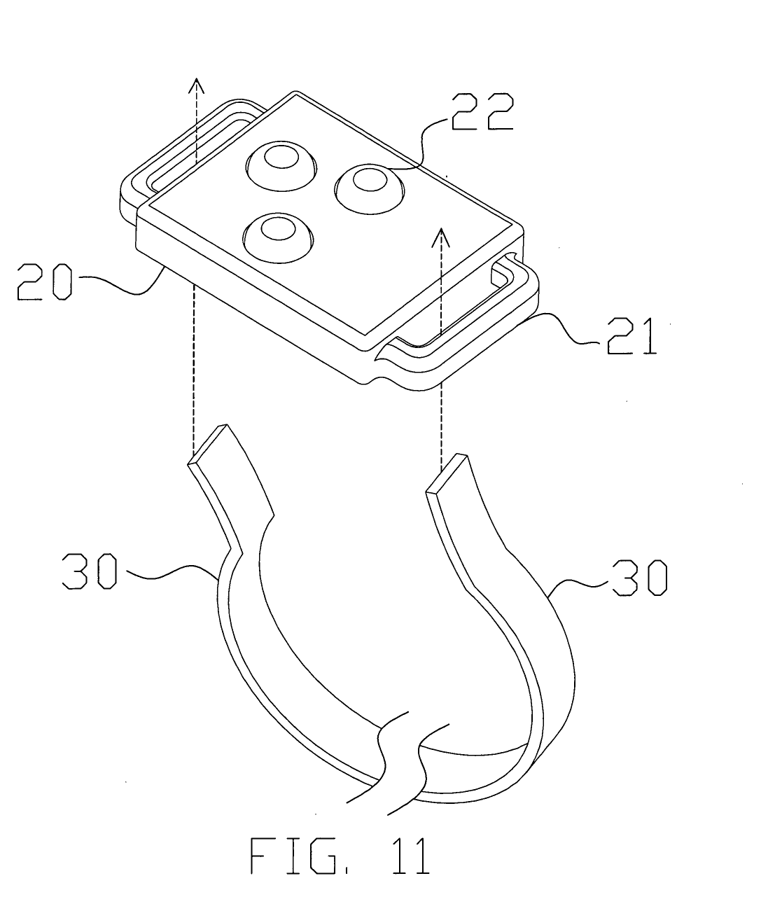

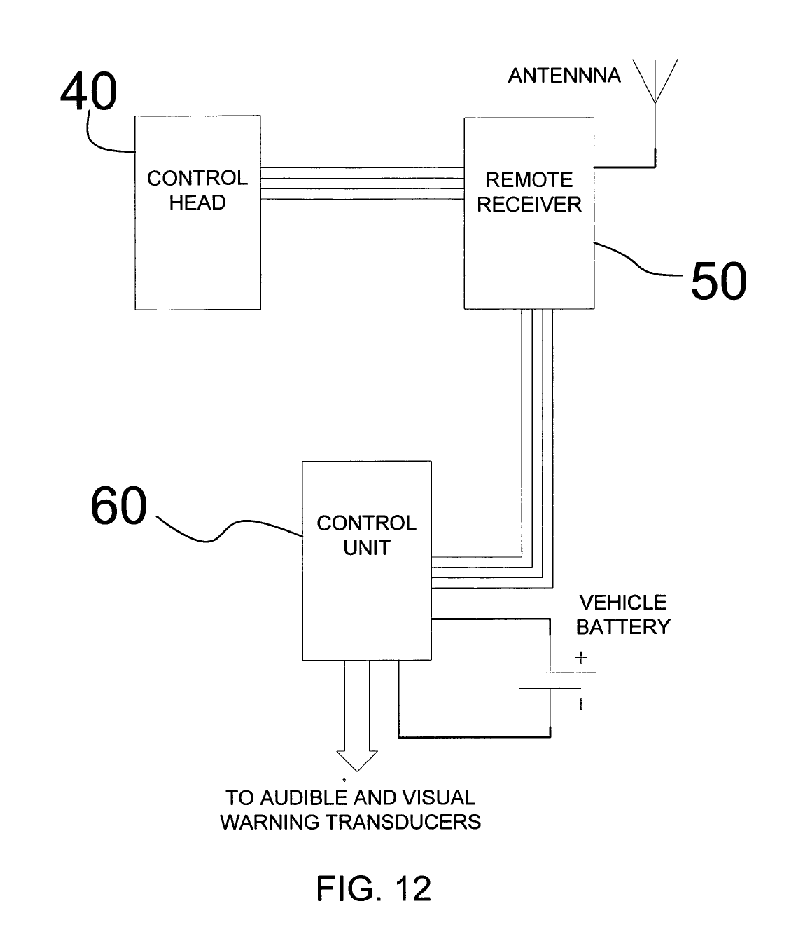

With reference to FIGS. 4, 6, 7, 11 and 12, a remote receiver (#50) embodying the function of receiving signal from the remote and controlling the control unit. As illustrated in FIGS. 4 and 6, the remote receiver comprises: the circuitry for RF reception A, the receiving microcontroller B, the power up reset circuit C, the EEPROM, type DS2431 circuit D, the control head interface circuitry E, and the driver interface circuitry F. It is noted that the circuitry for RF reception is circuit UAA3201T or an alternative embodiment with RF module RXM-433-LR as dashed rectangle shown in FIG. 7. Either the circuitry for RF reception A or the RF module receives signal with the carrier frequency at 433.92 MHz and demodulates the ASK signal to TTL voltage data. The receiving microcontroller B, more specifically either integrated circuit PIC16C58B or PIC16C715 will decode the TTL voltage data and issue control signal to the control unit (#60) through the driver interface circuitry F in response to the valid received data. The control head (#40) is also connected through its interface circuitry E and able to control the control unit together with the remote through the same interface F. As a result, the control head and the remote form redundant control links to operate the control unit in any case of one link fails to work.

The remote receiver can be mounted on the platform between the rear windshield and trunk or behind the rear seats and is capable of receiving the remote with different identification codes. The remote is mounted on the top of turning axis of the steering wheel's shaft (#10), and the remote has mounting slots (#21) on both sides, which allow Velcro nylon strips or similar fastening strap (#30) to be tied around the shaft of the steering wheel. The mounting location of the remote should be as close as possible to the front side of the steering wheel for easier touch by fingers but not to be an obstacle to the airbag deployment.

FIGS. 8 and 9 are the flow charts of the software programs executed by the remote and the remote receiver respectively. The control method of said vehicular wireless signal controller includes (1) encoding, configuring identification codes and transmitting of said remote (2) decoding and learning identification codes of said remote receiver and (3) controlling the audible and visual transducers.

### (1) Encoding, Configuring Identification Codes and Transmitting of Said Remote

After the battery in the remote is installed, depending on the programming switch S9, the microcontroller rfPIC16F675F inside the remote will boot up successfully if S9 is at off position.

If and only if the microcontroller rfPIC12F675F has successful booted up, the microcontroller reads the value of its internal free running clock as its unique identification codes and store it into its internal EEPROM with the switch S9 turned to its on position.

Turning switch S9 to off position completes the identification codes programming of the remote. The microcontroller inside the remote then creates a data string consists of synchronization, identification, control, and CRC-8 codes to be ready for transmission upon a keystroke. The control codes as set forth, depending on keys and single or double switch depresses will invoke different predefined data as its control command.

During most of operation, the microcontroller rfPIC12F675F is at sleep mode. It returns to full powered or awaken mode for three seconds whenever a keystroke is detected and then goes into sleep mode again for power saving.

Once a valid keystroke is detected, the microcontroller rfPIC12F675F will transmit the predefined data string according to the key and how many times the key is depressed.

### Explanation of FIG. 8

See S101. After the battery is installed, depending on the programming enabling switch, the microcontroller inside the remote will boot up successfully if the programming enabling switch is at off position.
See S102. After been successful powered up, the microcontroller inside the remote initializes its input and output ports and the timers including watchdog timer. Conversely, the microcontroller will stops from running further if the programming enabling switch is at on position while the microcontroller powers up.
See S103. The pre-stored identification codes in EEPROM will be read to the microcontroller in the remote.
See S104. The value of the free running clock will be read and arranged to form the unique identification codes of the remote if the programming enabling switch is at on position at this time. Contrast to S101 and S102, the identification codes will possibly become the same number to different remote if the microcontroller read the free running clock at power up since each power up process can take the same amount of time. Thus the programming enabling switch must be turned off at power up, or the software program will not be executed continuously.
See S105. The microcontroller in the remote keeps reading the switch inputs and will go into sleep mode if there is no switch input for three seconds.
See S106. When a switch input is detected, the microcontroller in the remote de-bounces the input, detects single or double depresses. If the input is valid, the synchronization, identification, control and CRC-8 codes will be transmitted through RF circuitry.
See both S110 and S111. After no switch input is detected in three seconds, the microcontroller in the remote goes into sleep mode. A switch input will wake up the microcontroller if it's in sleep mode. The microcontroller will check the programming enabling switch again and runs back to the process S104 after it is waken up from sleep mode.
See S109. Upon completing the identification codes programming, the microcontroller in the remote has learned the identification by saving the codes into EEPROM. Conversely, the microcontroller determines whether the identification programming is complete by checking the status of the programming enabling switch.
The power up reset circuit in the remote supervises the initial voltage at power up to ensure the voltage being stable before the RF controller rfPIC12F675F starts working. After the RF controller rfPIC12F675F starts working, a reset command to the internal watchdog timer is necessary before the watchdog timer overflows and resets the RF controller rfPIC12F675F. This conversely ensures the watchdog resetting routine to be executed within a limited time or the controller being still running properly. In order to reduce the numbers of push button, each push button detects single and double depresses and responds with different function.

### (2) Decoding and Learning Identification Codes of a Wireless Receiver

After said remote receiver is powered up, depending on the programming switch S1, the remote receiver will learn the identification codes from the incoming RF signal sent by said remote and save the data into EEPROM, an integrated circuit DS2431 with if and only if the condition that the switch S1 is closed, and the valid calculated CRC-8 and predefined control codes are received.

Switching S1 to off position in the remote receiver to complete the process for learning identification codes sent by the corresponding remote. Once the identification codes have been learned by the remote receiver, the corresponding remote and the remote receiver will form a pair of wireless transmitter and receiver.

During the normal operation, S1 in the remote receiver is reset to off and the remote receiver receives the incoming RF signal and determines its validity based on the synchronization, identification, control and CRC-8 codes.

Only CRC-8 is verified correctly, will the received identification code compare to the saved identification code in EEPROM DS2431 in the remote receiver.

After the valid identification codes are received, the remote receiver reads the control codes and identifies them with the predefined control command.

### Explanation of FIG. 9

See S201. After power up, the microcontroller in the remote receiver will decide to learn the identification code of the corresponded remote based on the programming enabling switch.
See S203. If the programming enabling switch has turned on, the microcontroller in the remote receiver will take the first accurately received identification data from the remote and save it to the EEPROM memory, integrated circuit DS2431. It should also be noted that the remote receiver and the remote have the same synchronization string, control code and CRC-8 error checking algorithm. The only unknown part of the communication protocol is the identification code. The remotes receiver is able to retrieve the identification code based on the other three strings of data are received accurately.
See 205. Upon completion of the identification learning process, the microcontroller in the remote receiver goes into its normal operating procedures.
See 202 and 206. On the contrary, if the programmable enabling switch is not turned on, or the identification learning process has completed, the microcontroller in the remote receiver will initialize its input and output ports, setup timers including watchdog timer and read the pre-stored identification code from EEPROM.
See 207. Data received under the carrier frequency 433.92 MHz will be examined by verifying its synchronization string which comprises 16 digital 1 and 4 digital 0 and should have bit timing set at 256 uS. If the synchronization string is successfully received, the program execution will proceed to the next process or the microcontroller in the remote receiver will discard the invalid data and continue to check the incoming signal.
See 208. Only the synchronization string is received correctly, will the microcontroller in the remote receiver verify the identification, control and CRC-8 codes to determine if a valid communication has been received. If received incorrectly, the process will go back to S207 and continue examining incoming data.

### (3) Controlling the Audible and Visual Transducers

If the received control codes are valid, the remote receiver sends command to said control unit to turn siren amplifiers or emergency lights on or off.

After completing the control of siren amplifier or emergency lights, the electricity of the control unit will be removed when the system idles for 30 minutes. However the remote receiver needs to be in power and capable of receiving RF signal from the wireless transmitted transmitters at all times.

See S301 of FIG. 9 Upon a valid communication is received, the microcontroller in the remote receiver will decode the control code, identify its function and send the command through the hardwired link to the control unit. Siren amplifier or emergency light switches in the control unit will be turned on or off in accordance with the command sent from the remote receiver.
See S302. After the remote receiver receives no valid data for thirty minutes and none of the siren amplifier or emergency light is activated, which is under the idle situation, the remote receiver will turn off the electricity for the control unit. It should also be noted that the control head has the power on/off switch to the control unit. The remote receiver is connected between the control head and the control unit, so it can override the power on/off command issued from the control head. Alternatively, since the remote receiver also receives the control command from the remote, the power of the control unit can be turned on when it is off by the remote directly, upon a switch pushed. For instance, depressing the air horn button on the remote will immediately turn on the power for the control unit through the remote receiver if the control unit is off. After the air horn ring sounds, the control unit becomes idle and will be turned on if the remote receiver receives no further valid data from both the control head and the remote for thirty minutes. However, the power to the remote receiver has to be remained on at all times.

The communication protocol between the remote and the remote receiver is comprised of the following components in such order:

| | | | | |
|---|---|---|---|---|
| Synchronization | Identification | Identification | Control | Cyclical |
| | | | | Redundant |
| | | | | Code-8 |

The protocol contains four sections: synchronization, identification, control and CRC-8 codes wherein the bit timing is set at 256 uS and encoded with Manchester code. The synchronization code has 20 bits including 16 of digital 1 and 4 of digital 0. There are sixteen bits in the identification codes, which comprise two eight bytes. Only the synchronization codes are received correctly by the remote receiver, will the received identification and control codes is calculated to generate CRC-8 codes for error checking.

Depending on the keys and whether a single or double key depresses, the microcontroller in the remote will invoke different predefined values as its control command and send it through the RF link to the remote receiver, which has the same definition for the control command in its microcontroller. The control codes of said vehicular wireless signal controller are predefined and different for cases that either a single or double key depresses is detected on the same switch. The detection of single or double depresses is accomplished by the software program in the remote, and two consecutive keystrokes within 300 mS is recognized as double depressed. Also switch de-bouncing time is set to 30 mS.

It is obvious that the advantage of the disclosed invention is to increase driving safety by not changing the focus of the driver's attention. These characteristics are important advantages in a dangerous situation that requires driver's total concentration in the events of emergency condition. Moreover, the fact that said remote is installed on the top of the rotational steer wheel with reduced number of buttons and can be operated different function in single or double depresses helps the driver focus on the road condition. In effect, the invention improves the safety while driving an emergency vehicle.

It is to be understood that the invention is not limited in its application to the details of construction and to the arrangements of the components set forth in the above description or illustrated in the drawings. For instance, altering the communication protocol, encoding with non-return-to-zero, bipolar 8 zero substitution or other equivalent codes and so forth, and modulated with FM, PM, FSK or other equivalent digital modulation or all suitable modification and equivalents may be resorted to, will fall within the scope of the invention.

Further, for designers, engineers and practitioners those who skilled in the art of electronics will appreciate that the concept may readily be utilized as a basis for the design of other structures, methods and systems for carrying out several purposes of the present invention. It is important, therefore, that the claims be regarded as including such equivalent constructions insofar as they do not depart from the spirit and scope of the present invention.

What I claim as my invention is:

1. A vehicular wireless signal controller comprising:
(a) a remote which is installed on the top of a steeling wheel's shaft and can send control signals to a remote receiver,
(b) a remote receiver which can receive control signals from said remote and a control head,
(c) a control head with a microphone which can send control signals to said remote receiver, and
(d) a control unit which receives control signals from said remote receiver and use the signals to control audible and visual transducers.

2. A control method of a vehicular wireless signal controller comprising the steps:
(a) providing said remote which encodes and configures identification codes and send these codes to said remote receiver,
(b) providing said remote receiver which decodes and learns identifications codes from said remote, and
(c) providing said remote receiver which sends command to said control unit to turn siren amplifiers or emergency lights on or off.
